(19) United States
(12) Patent Application Publication
(10) Pub. No.: US 2021/0261753 A1
(43) Pub. Date: Aug. 26, 2021

(54) PHENYLPHOSPHINO COMPOUNDS AS PROCESS STABILIZERS

(71) Applicant: Clariant International Ltd, Muttenz (CH)

(72) Inventors: Damien BISSESSAR, Strasbourg (FR); Stephane Bellemin LAPONNAZ, Strasbourg (FR); Pascal STEFFANUT, Village Neuf (FR)

(73) Assignee: Clariant International Ltd, Muttenz (CH)

(21) Appl. No.: 17/252,603

(22) PCT Filed: Jun. 21, 2019
(86) PCT No.: PCT/EP2019/066483

§ 371 Date: Dec. 15, 2020

(30) Foreign Application Priority Data
Jun. 20, 2018 (EP) 18178820.9

(51) Int. Cl. C08K 5/50; C08K 5/101

(52) U.S. Cl. CPC C08K 5/50; C08K 5/101

(57) ABSTRACT

The invention relates to a composition comprising one or more polymers as component A and one or more diphenylphosphino compounds, in particular diphenylphosphino (meth)acrylate or (meth)acrylamide based compounds, as component B. Further, the present invention relates to the use of such diphenylphosphino compounds for stabilizing a polymer composition with respect to exposure to heat and/or mechanical stress during processing.

The present invention relates to compositions comprising one or more polymers as component A and one or more diphenylphosphino compounds, in particular diphenylphosphino (meth)acrylate or (meth)acrylamide based compounds, as component B. Furthermore, the invention is directed to the use of such diphenylphosphino compounds for stabilizing polymer compositions with respect to exposure to heat and/or mechanical stress during processing.

The processing of polymer molding compositions (masses) and polymer blends typically involves the exposure of heat and mechanical stress. In particular, thermoplastic molding masses such as polyolefins, polystyrene (co)polymers, polyurethanes, polyesters, polyamides, polyacetals and blends and copolymers of two or more thereof are typically melt during processing and often extruded, blow-formed or subjected to injection molding which involves mechanical stress. The heat and/or mechanical stress during processing may lead to decomposition of the polymer compositions. Depending on the polymer type, such decomposition may lead to an undesired reduction of chain length (typically decreasing viscosity of the melt).and/or to an undesired crosslinking of polymer strands (typically increasing viscosity of the melt). The viscosity of the polymer melt at a given temperature may alter.

Therefore, stabilizing agents are described in the art. Several phosphorus compounds, such as organo-phosphites and -phosphonites, have been described as being usable to stabilize polymeric compounds during processing. These stabilizers may reduce damage to the polymer through exposure to heat and/or mechanical stress during processing.

However, a disadvantage of these compounds is relatively pronounced susceptibility to hydrolysis and the need to use amounts typically in the range above 500 ppm in order to achieve sufficient stabilizing action. Such comparably high contents may be undesired for several applications.

The precise amounts used depend on the polymer type and on the application sector envisaged. Optimum application concentrations and conditions can be adapted individually by suitable trials. Further some organophosphites such as TNPP (tris(nonylphenyl)phosphite) may have undesired side effects on the environment.

Another group of appropriate compounds are organo-phosphanes, which unlike the organophosphites and organophosphonites contain no hydrolysable P—O bonds. No detrimental hydrolysis can therefore occur with these compounds. The suitability of such phosphane compounds, wherein unsubstituted alkyl and phenyl residues are directly linked to a central phosphorous atom has been described in old patents U.S. Pat. Nos. 3,637,907 and 2,981,716. Nevertheless, this class of compounds is not yet used in practice on commercial scale. These compounds often require comparably high amounts and show a moderate activity in stabilizing. Thus, such compounds do not provide substantial advantage in effectiveness over the stabilizers used before. More efficient compounds are described in WO 2002/102886. The synthesis of the bis-diphenylphosphine-alkane compounds described therein is, however, challenging. Further, some compounds of this type have an undesirably low biodegradability and may show undesired bioaccumulation due to a rather high lifetime.

Therefore, there is still the unmet need of compounds for stabilizing a polymer composition with respect to exposure to heat and/or mechanical stress during processing which are well synthetically obtainable and show reduced bioaccumulation.

Surprisingly, it has been found that a composition comprising one or more polymers as component A and one or more diphenylphosphino (meth)acrylate- or (meth)acrylamide-based compounds as component B show unexpectedly high stability, even at low content ranges of component B. The compounds of component B are synthetically obtainable without burden. Furthermore, these compounds of the present invention contain ester or amide functionalities that allow a possible decomposition in the environment just by saponification and diminishing thereof the risk of bioaccumulation.

Accordingly, in a first aspect, the present invention relates to a composition comprising (or consisting of):
A) one or more polymers as component A;
B) one or more diphenylphosphino compounds of the formula (I) as component B

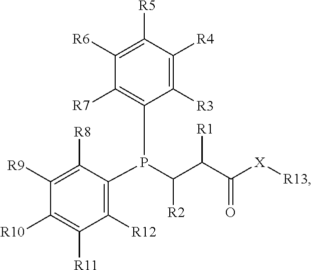

where, independently of one another

R1 is selected from the group consisting of linear or branched C₁₋₁₂-alkyl, hydrogen, and carboxylate from the formula COOR^{a}, wherein R^{a} is linear or branched C₁₋₂₀-alkyl;

R2 is selected from the group consisting of hydrogen, linear or branched C₁₋₁₈-alkyl, and linear or branched C₁₋₁₂-alkoxy;

R3 to R12 are each independently from each other selected from the group consisting of hydrogen, linear or branched C₁₋₁₈-alkyl, and linear or branched C₁₋₁₂-alkoxy;

X is O or NH;

P is phosphorous; and

R13 is selected from the group consisting of linear or branched C₁₋₂₀-(cyclo)alkyl, linear or branched C₁₋₂₀-(cyclo)heteroalkyl, C₆₋₃₀-aryl, C₁₋₂₉-heteroaryl, alkyl terminated polyethylene glycol, and polypropylene glycol chain,

wherein the residues of R13 may optionally be substituted by one or more linear or branched C₁₋₂₀-(cyclo)alkyl residues, linear or branched C₁₋₂₀-(cyclo)heteroalkyl residues, C₆₋₃₀-aryl residues, or C₁₋₂₉-heteroaryl residues, and

wherein two or more residues R13 of two or more diarylphosphino units of formula (I) may optionally be conjugated with another; and
C) optionally one or more polymer additives as component C.

In a preferred embodiment, the amounts of the components A), B) and C) sums up to 100% by weight.

As used throughout the present application, the term “alkyl” may be understood in the broadest sense as both, linear or branched chain alkyl residue. Preferred alkyl residues are those containing from one to 20 carbon atoms. In a preferred embodiment, alkyl residues contain from one to ten carbon atoms or from one to four carbon atoms. Exemplarily, an alkyl residue may be methyl, ethyl, propyl, isopropyl, butyl, isobutyl or tert-butyl. The term “heteroalkyl” may be understood in the broadest sense as both, linear or branched chain alkyl residue that includes at least one heteroatom, for example ma bear from one to three heteroatoms. Typically, the heteroatom may replace a carbon atom. The valencies are adapted accordingly. As far as not otherwise indicated, an alkyl or heteroalkyl may also be optionally substituted by one or more substituents. A (hetero)cycloalkyl refers to the respective cyclic structure that is typically an aliphatic cyclic structure. The terms “alkylene”, “heteroalkylene”, “cycloalkylene” and “heterocycloalkylene” refer to bivalent residues that each bear two binding sites to other molecular structures and thereby serve as a linker structure.

As used throughout the present invention, an heteroatom may be any heteroatom, in particular a di-, tri- or tetravalent atom, such as, e.g., oxygen, nitrogen, sulfur, silicium, or a combination of two or more thereof, which may be optionally further substituted. It will be understood that when an heteroatom replaces a carbon atom, the valency and number or hydrogen atoms will be adapted accordingly. Accordingly, a residue comprising one or more heteroatoms may, for example, comprise a group selected from —O—, —NH—, ═N—, —NCH₃—, —Si(OH)₂—, —Si(OH)CH₃—, —Si(CH₃)₂—, —O—Si(OH)₂—O—, —O—SiOCH₃—O—, —O—Si(CH₃)₂—O—, —S—, —SO—, —SO₂—, —SO₃—, —SO₄—, or a salt thereof.

As used throughout the present application, the term “aryl” may be understood in the broadest sense as any mono-, bi- or polycyclic aromatic moiety. Preferably, an aryl is a C₆-C₃₀-aryl, more preferably a C₆-C₁₄-aryl, even more preferably a C₆-C₁₀-aryl, in particular a C₆-aryl. The term “heteroaryl” may be understood in the broadest sense as any mono-, bi- or polycyclic heteroaromatic moiety that includes at least one heteroatom, in particular which bears from one to three heteroatoms per aromatic ring. Preferably, a heteroaryl is a C₁-C₂₉-aryl, more preferably a C₁-C₁₃-aryl, even more preferably a C₁-C₉-aryl, in particular a C₁-C₆-aryl. Accordingly, the terms “arylene” and “heteroarylene” refer to the respective bivalent residues that each bear two binding sites to other molecular structures and thereby serve as a linker structure.

Exemplarily, a heteroaryl may be a residue of furan, pyrrole, imidazole, oxazole, thiazole, triazole, thiophene, pyrazole, pyridine, pyrazine or pyrimidine. As far as not otherwise indicated, an aryl or heteroaryl may also be optionally substituted by one or more substituents. An aryl or heteroaryl may be unsubstituted or substituted.

It will be understood that when two or more residues R13 of two or more diarylphosphino units of formula (I) may optionally be conjugated with another, the respective residue R13 will be a bivalent, trivalent or tetravalent moiety or even a moiety of even higher valency. It will be understood that then, the respective residues are (hetero)alkylene, (hetero)cycloalkylene, (hetero)arylene residues etc., which are, as far as not otherwise defined, defined as the monovalent residues as defined above.

The term “alkenyl” may be understood in the broadest sense as both, linear or branched chain alkenyl residue, i.e. a hydrocarbon comprising at least one double bond. An alkenyl may optionally also comprise two or more double bonds. Preferred alkenyl residues are those containing from two to 20 carbon atoms. More preferred alkenyl residues are those containing from two to ten carbon atoms. Particularly preferred alkenyl residues are those containing from two to four carbon atoms. The term “heteroalkenyl” may be understood in the broadest sense as both, linear or branched chain alkenyl residue that includes at least one heteroatom, in particular which bears from one to three heteroatoms. As far as not otherwise indicated, an alkenyl or heteroalkenyl may also be optionally substituted by one or more substituents. A (hetero)cycloalkenyl refers to the respective cyclic structure that is typically an aliphatic cyclic structure. The terms “alkenylene”, “heteroalkenylene”, “cycloalkenylene” and “heterocycloalkenylene” refer to bivalent residues that each bear two binding sites to other molecular structures and thereby serve as a linker structure.

The term “alkinyl” may be understood in the broadest sense as both, linear or branched chain alkinyl residue, i.e. a hydrocarbon comprising at least one double bond. An alkinyl may optionally also comprise two or more double bonds. Preferred alkinyl residues are those containing from two to 20 carbon atoms. More preferred alkinyl residues are those containing from two to ten carbon atoms. Particularly preferred alkinyl residues are those containing from two to four carbon atoms.

The term “heteroalkinyl” may be understood in the broadest sense as both, linear or branched chain alkinyl residue that includes at least one heteroatom, in particular which bears from one to three heteroatoms. As far as not otherwise indicated, an alkinyl or heteroalkinyl may also be optionally substituted by one or more substituents. A (hetero)cycloalkinyl refers to the respective cyclic structure that is typically an aliphatic cyclic structure. The terms “alkinylene”, “heteroalkinylene”, “cycloalkinylene” and “heterocycloalkinylene” refer to bivalent residues that each bear two binding sites to other molecular structures and thereby serve as a linker structure.

It will be noticed that hydrogen can, at each occurrence, be replaced by deuterium.

As used throughout the present application, the term “unsubstituted” may be understood in the broadest sense as generally understood in the art. Thus, in accordance with general understanding, an unsubstituted residue may consist of the chemical structure defined and, as far as appropriate, one or more hydrogen atoms bound to balance valency.

As used throughout the present application, the term “substituted” may be understood in the broadest sense as generally understood in the art. Thus, a substituted residue may comprise the chemical structure described and one or more substituents. In other words, one or more hydrogen atoms balancing valency are typically replaced by one or more other chemical entities. Preferably, a substituted residue comprises the chemical structure described and one substituent. In other words, then, one hydrogen atom balancing valency is replaced by another chemical entity. For instance, a substituent may be an atom or a group of atoms which replaces one or more hydrogen atoms on the parent chain of a hydrocarbon residue.

As far as not otherwise defined herein, a substituent may be any substituent. Preferably, a substituent does either not comprise more than 30 carbon atoms. For example, a substituent may be selected from the group consisting of —R^{a}—R^{b}, —R^{a}—CO—O—R^{b}, —R^{a}—O—CO—R^{b}, —R^{a}—O—R^{b}, —R^{a}—CO—NH—R^{b}, —R^{a}—NH—CO—R^{b}, —R^{a}—NH—R^{b}, —R^{a}—CO—R^{b}, (preferably alkyl terminated) di- or polyethylene glycol, di- or polypropylene glycol, and a halogen, wherein

R^{a} is a single bond, an (unsubstituted or substituted) C₁-C₂₀-alkylene residue, an (unsubstituted or substituted) C₂-C₂₀-alkenylene residue, or an (unsubstituted or substituted) C₂-C₂₀-alkinylene residue; and R^{b} is an (unsubstituted or substituted) C₁-C₂₀-(hetero)alkyl residue, an (unsubstituted or substituted) C₁-C₂₀-(hetero)alkenyl residue, an (unsubstituted or substituted) C₁-C₂₀-(hetero)alkinyl residue, an (unsubstituted or substituted) C₁-C₂₀-(hetero)cycloalkyl residue, an (unsubstituted or substituted) C₁-C₂₀-(hetero)cycloalkenyl residue, an (unsubstituted or substituted) C₁-C₂₀-(hetero)cycloalkinyl residue, or an (unsubstituted or substituted) C₁-C₂₀-(hetero)aromatic residue, wherein preferably the substituent (as a whole) does either not comprise more than 30 carbon atoms.

More preferably, the substituent (as a whole) does either not comprise more than 20 carbon atoms, even more preferably not more than 10 carbon atoms, in particular not more than 4 carbon atoms. The person skilled in the art will immediately understand that the definitions of R^{a} and R^{b} have to be adapted accordingly.

For example, in a particularly preferred embodiment, the defined residues are unsubstituted or are substituted with one substituent that does not comprise more than 4 carbon atoms, wherein a substituent may be selected from the group consisting of —R^{a}—R^{b}, —R^{a}—CO—O—R^{b}, —R^{a}—O—CO—R^{b}, —R^{a}—O—R^{b}, —R^{a}—CO—NH—R^{b}, —R^{a}—NH—CO—R^{b}, —R^{a}—NH—R^{b}, —R^{a}—CO—R^{b}, (preferably alkyl terminated) di- or polyethylene glycol, or di- or polypropylene glycol; wherein R^{a} is an unsubstituted C₁-C₄-alkylene residue, an unsubstituted C₂-C₄-alkenylene residue, or an unsubstituted C₂-C₄-alkinylene residue; and R^{b} is an unsubstituted C₁-C₄-(hetero)alkyl residue, an unsubstituted C₁-C₄-(hetero)alkenyl residue, an unsubstituted C₁-C₄-(hetero)alkinyl residue, an unsubstituted C₁-C₄-(hetero)cycloalkyl residue, an unsubstituted C₁-C₄-(hetero)cycloalkenyl residue, an unsubstituted C₁-C₄-(hetero)cycloalkinyl residue, or an (unsubstituted or substituted) C₁-C₄-(hetero)aromatic residue.

In a preferred embodiment, a substituent may be selected from the group consisting of —R^{a}—R^{b}, —R^{a}—CO—O—R^{b}, —R^{a}—O—CO—R^{b}, —R^{a}—O—R^{b}, (preferably alkyl terminated) di- or polyethylene glycol, di- or polypropylene glycol, wherein R^{a} and R^{b} are defined as above.

In a particularly preferred embodiment, a substituent is selected from the group consisting of —R^{a}—R^{b}, —R^{a}—CO—O—R^{b}, —R^{a}—O—CO—R^{b}, —R^{a}—O—R^{b}, wherein R^{a} and R^{b} are defined as above and the substituent does not comprise more than 30 carbon atoms, more preferably does not comprise more than 20 carbon atoms, even more preferably does not comprise more than 10 carbon atoms, in particular does not comprise more than 4 carbon atoms. The person skilled in the art will immediately understand that the definitions of R^{a} and R^{b} have to be adapted accordingly as laid out above.

In a preferred embodiment, the compound of component B has a neutral net charge. As used herein, the term “neutral net charge” may be understood in the broadest sense as not having a charge (positive (+) or negative (−)) over the whole compound of component B, i.e., have net zero charge. In a preferred embodiment, the compound of component B does not have an ionic group at all, in other words, is uncharged. In an alternative preferred embodiment, the compound of component B may be zwitterionic.

Component B (i.e., one or more components of formula (I)) may also be designated as stabilizing agent or stabilizer.

An polypropylene glycol chain may be any polypropylene glycol chain. In a preferred embodiment, the polypropylene glycol chain as used herein is a polypropylene glycol chain of not more than 30 carbon atoms. In a preferred embodiment, an polypropylene glycol chain may have the general formula:

#-(CH₂)ₙ—(O—CH₂—CH₂—CH₂)ₘ—(CH₂)ₒ-#,

#-(CH₂)ₙ—(O—CH₂—CH₂—CH₂)ₘ—(CH₂)ₚ—CH₃,

#-(CH₂)ₙ—(CH₂—CH₂—CH₂—O)ₘ—(CH₂)ₒ#, or

#-(CH₂)ₙ—(CH₂—CH₂—CH₂—O)ₘ—(CH₂)ₚ—CH₃,

wherein:

n is an integer from 1 to 10,

m is an integer from 1 to 10,

o is an integer from 1 to 10,

p is an integer from 0 to 10,

# is a binding site to X of a compound of component B, and the alkyl terminated polyethylene glycol of not more than 30 carbon atoms.

An alkyl terminated polyethylene glycol may be any alkyl terminated polyethylene glycol. In a preferred embodiment, the alkyl terminated polyethylene glycol as used herein is a alkyl terminated polyethylene glycol of not more than 30 carbon atoms. In a preferred embodiment, an alkyl terminated polyethylene glycol may have the general formula:

#-(CH₂)ₙ—(O—CH₂—CH₂)ₘ—(CH₂)ₒ-#,

#-(CH₂)ₙ—(O—CH₂—CH₂)ₘ—(CH₂)ₚ—CH₃,

#-(CH₂)ₙ—(CH₂—CH₂—O)ₘ—(CH₂)ₒ-#, or

#-(CH₂)ₙ—(CH₂—CH₂—O)ₘ—(CH₂)ₚ—CH₃,

wherein:

n is an integer from 1 to 10,

m is an integer from 1 to 10,

o is an integer from 1 to 10,

p is an integer from 0 to 10,

# is a binding site to X of a compound of component B, and the alkyl terminated polyethylene glycol of not more than 30 carbon atoms.

In a preferred embodiment, R^{a} is linear or branched C₁₋₁₂ alkyl. In a preferred embodiment, R^{a} is linear or branched C₁₋₆ alkyl. In a preferred embodiment, R^{a} is linear or branched C₁₋₄ alkyl.

In a preferred embodiment, X is O. Alternatively, X may be N.

In a preferred embodiment, at least 8 of R2 to R12 are each hydrogen. In a preferred embodiment, R2 is hydrogen. In a preferred embodiment, at least 8 of R2 to R12 are each hydrogen and R2 is hydrogen. In a preferred embodiment, all of R2 to R12 are each hydrogen.

In a preferred embodiment, in the compound of formula (I) independently of one another:

R1 is C₁₋₂₀-alkyl, linear or branched; carboxylate from the formula COOR^{a} wherein R^{a} is a linear or branched C₁₋₂₀-alkyl;

R3 to R12 are independently from each other selected from hydrogen, linear or branched C₁₋₁₈-alkyl, and linear or branched C₁₋₁₂-alkoxy;

X is O or NH;

R13 is linear or branched C₁₋₂₀-alkyl, an alkyl terminated polyethylene glycol, phenyl, substituted phenyl, or a polypropylene glycol chain, as possible structural moieties may optionally form a bridge in between two diarylphosphino units.

In a preferred embodiment, in the compound of formula (I), R13 is selected from the group consisting of linear or branched C₁₋₁₅-(cyclo)alkyl, linear or branched C₁₋₁₅-(cyclo)heteroalkyl, C₆₋₁₀-aryl, C₁₋₁₀-heteroaryl, alkyl terminated polyethylene glycol, and polypropylene glycol chain,

wherein the residues of R13 may optionally be substituted by one or more linear or branched C₁₋₁₅-(cyclo)alkyl residues, linear or branched C₁₋₁₅-(cyclo)heteroalkyl residues, C₆₋₁₀-aryl residues, or C₁₋₁₀-heteroaryl residues, and

wherein two or more residues R13 of two or more diarylphosphino units of formula (I) may optionally be conjugated with another

In a preferred embodiment, in the compound of formula (I), R13 is selected from the group consisting of linear or branched C₁₋₁₀-(cyclo)alkyl, phenyl, and linear or branched C₁₋₁₀-(cyclo)heteroalkyl, wherein the residues of R13 may optionally be substituted by one or more linear or branched C₁₋₅-(cyclo)alkyl residues or linear or branched C₁₋₅-(cyclo)heteroalkyl residues, and wherein two or more residues R13 of two or more diarylphosphino units of formula (I) may optionally be conjugated with another.

In a preferred embodiment, in the compound of formula (I), independently of one another:

R1 is selected from the group consisting of linear or branched C₁₋₅-alkyl, hydrogen, and carboxylate from the formula COOR^{a}, wherein R^{a} is linear or branched C₁₋₅-alkyl; R2 is hydrogen;

R3 to R12 are each independently from each other selected from the group consisting of hydrogen, linear or branched C₁₋₅-alkyl, and linear or branched C₁₋₅-alkoxy, wherein at least 8 of R3 to R12 are hydrogen;

X is O or NH; P is phosphorous; and

R13 is selected from the group consisting of linear or branched C₁₋₁₅-(cyclo)alkyl, linear or branched C₁₋₁₅-(cyclo)heteroalkyl, C₆₋₁₀-aryl, C₁₋₁₀-heteroaryl, alkyl terminated polyethylene glycol, and polypropylene glycol chain,

wherein the residues of R13 may optionally be substituted by one or more linear or branched C₁₋₁₅-(cyclo)alkyl residues, linear or branched C₁₋₁₅-(cyclo)heteroalkyl residues, C₆₋₁₀-aryl residues, or C₁₋₁₀-heteroaryl residues, and

wherein two or more residues R13 of two or more diarylphosphino units of formula (I) may optionally be conjugated with another.

In a preferred embodiment, in the compound of formula (I), independently of one another: R1 is selected from the group consisting of linear or branched C₁₋₅-alkyl, hydrogen, and carboxylate from the formula COOR^{a}, wherein R^{a} is linear or branched C₁₋₅-alkyl; R2 is hydrogen;

R3 to R12 are each hydrogen; X is O or NH; P is phosphorous; and

R13 is selected from the group consisting of linear or branched C₁₋₁₀-(cyclo)alkyl, phenyl, and linear or branched C₁₋₁₀-(cyclo)heteroalkyl,

wherein the residues of R13 may optionally be substituted by one or more linear or branched C₁₋₅-(cyclo)alkyl residues or linear or branched C₁₋₅-(cyclo)heteroalkyl residues, and wherein two or more residues R13 of two or more diarylphosphino units of formula (I) may optionally be conjugated with another.

In a preferred embodiment, component B is selected from the group consisting of any of the compounds depicted in Tables 1A-D or a mixture of two or more thereof.

TABLE 1A
Monophosphino acrylates and -methacylates

| | | Physical state |
|---|---|---|
| | | and color |
| Compound | structural formula | (T = 20° C.) |
| B-1 | 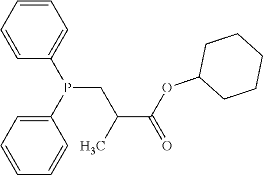 [SMILES: CC(CP(c1ccccc1)c1ccccc1)C(=O)OC1CCCCC1] | colorless oil |
| B-2 | 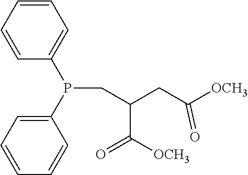 [SMILES: COC(=O)CC(CP(c1ccccc1)c1ccccc1)C(=O)OC] | colorless oil |
| B-3 | 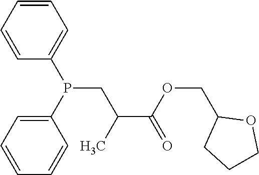 [SMILES: CC(CP(c1ccccc1)c1ccccc1)C(=O)OCC1CCCO1] | colorless oil |
| B-4 | 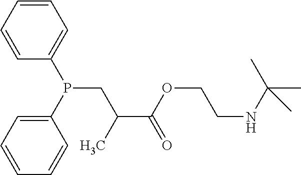 [SMILES: CC(CP(c1ccccc1)c1ccccc1)C(=O)OCCNC(C)(C)C] | colorless oil |
| B-5 | 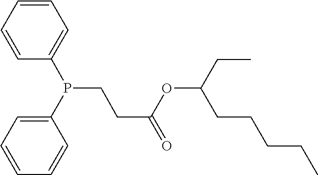 [SMILES: CCCCCC(CC)OC(=O)CCP(c1ccccc1)c1ccccc1] | colorless oil |
| B-6 | 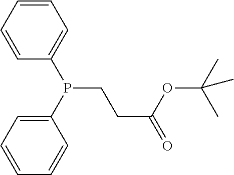 [SMILES: CC(C)(C)OC(=O)CCP(c1ccccc1)c1ccccc1] | colorless oil |
| B-7 | 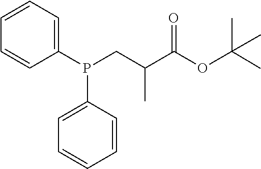 [SMILES: CC(CP(c1ccccc1)c1ccccc1)C(=O)OC(C)(C)C] | colorless oil |
| B-8 | 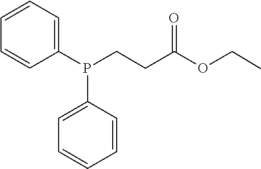 [SMILES: CCOC(=O)CCP(c1ccccc1)c1ccccc1] | colorless oil |
| B-9 | 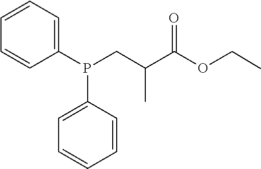 [SMILES: CCOC(=O)C(C)CP(c1ccccc1)c1ccccc1] | colorless oil |
| B-10 | 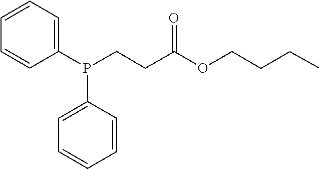 [SMILES: CCCCOC(=O)CCP(c1ccccc1)c1ccccc1] | colorless oil |
| B-11 | 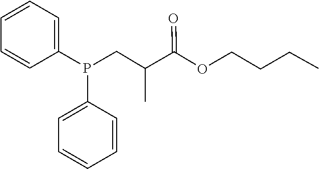 [SMILES: CCCCOC(=O)C(C)CP(c1ccccc1)c1ccccc1] | colorless oil |
| B-12 | 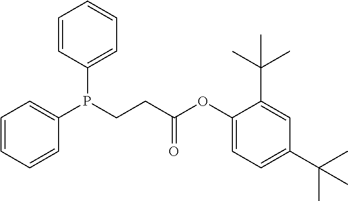 [SMILES: CC(C)(C)c1ccc(OC(=O)CCP(c2ccccc2)c2ccccc2)c(C(C)(C)C)c1] | |
| B-13 | 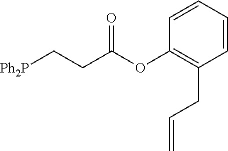 | |

TABLE 1B
Diphosphino acrylates and -methacylates

| | | Physical state |
|---|---|---|
| | | and color |
| | structure formula | (T = 20° C.) |
| B-II-1 | 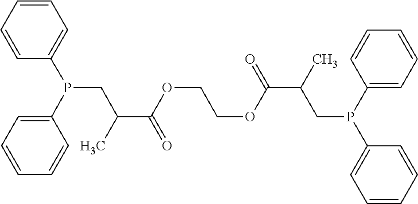 [SMILES: CC(CP(c1ccccc1)c1ccccc1)C(=O)OCCOC(=O)C(C)CP(c1ccccc1)c1ccccc1] | colorless oil |
| B-II-2 | 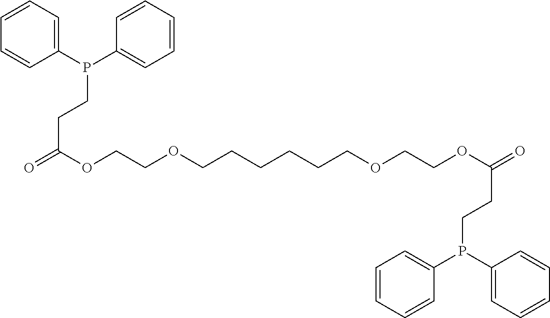 [SMILES: O=C(CCP(c1ccccc1)c1ccccc1)OCCOCCCCCCOCCOC(=O)CCP(c1ccccc1)c1ccccc1] | colorless oil |
| B-II-3 | 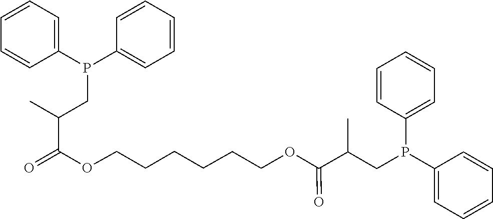 [SMILES: CC(CP(c1ccccc1)c1ccccc1)C(=O)OCCCCCCOC(=O)C(C)CP(c1ccccc1)c1ccccc1] | colorless oil |
| B-II-4 | 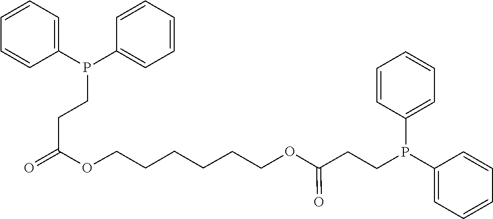 [SMILES: O=C(CCP(c1ccccc1)c1ccccc1)OCCCCCCOC(=O)CCP(c1ccccc1)c1ccccc1] | white powder |
| B-II-5 | 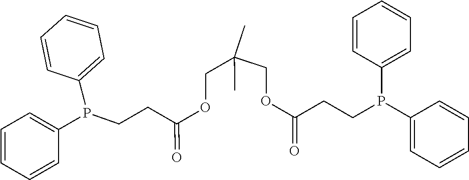 [SMILES: CC(C)(COC(=O)CCP(c1ccccc1)c1ccccc1)COC(=O)CCP(c1ccccc1)c1ccccc1] | white powder |
| B-II-6 | 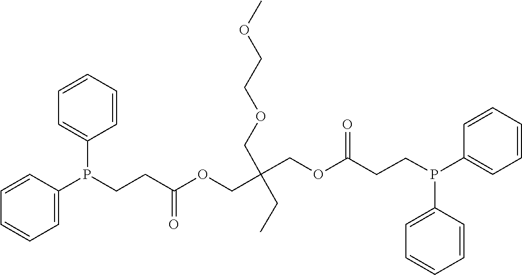 [SMILES: CCC(COCCOC)(COC(=O)CCP(c1ccccc1)c1ccccc1)COC(=O)CCP(c1ccccc1)c1ccccc1] | |

TABLE 1C
Triphosphino acrylates

| | | Physical state |
|---|---|---|
| | | and color |
| | structure formula | (T = 20° C.) |
| B-III-1 | 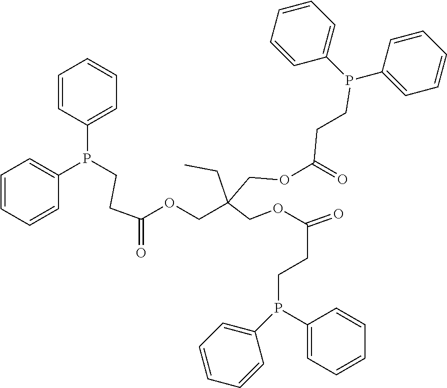 [SMILES: CCC(COC(=O)CCP(c1ccccc1)c1ccccc1)(COC(=O)CCP(c1ccccc1)c1ccccc1)COC(=O)CCP(c1ccccc1)c1ccccc1] | white powder |
| B-III-2 | 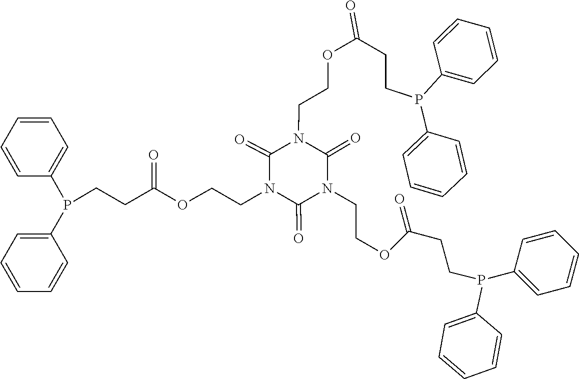 [SMILES: O=C(CCP(c1ccccc1)c1ccccc1)OCCn1c(=O)n(CCOC(=O)CCP(c2ccccc2)c2ccccc2)c(=O)n(CCOC(=O)CCP(c2ccccc2)c2ccccc2)c1=O] | colorless oil |
| B-III-3 | 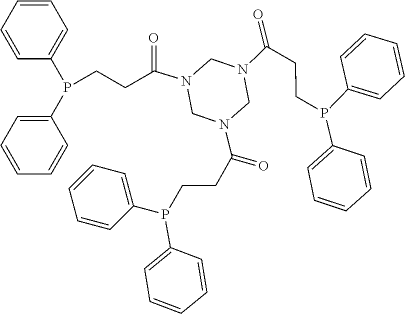 [SMILES: O=C(CCP(c1ccccc1)c1ccccc1)N1CN(C(=O)CCP(c2ccccc2)c2ccccc2)CN(C(=O)CCP(c2ccccc2)c2ccccc2)C1] | |

TABLE 1D
Tetraphosphino acrylates

| | | Physical state |
|---|---|---|
| | | and color |
| | structure formula | (T = 20° C.) |
| B-IV-1 | 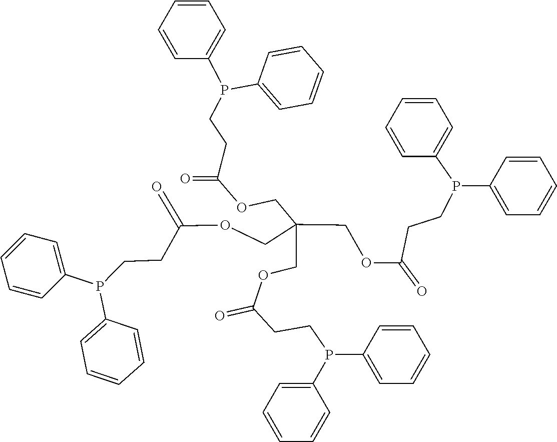 [SMILES: O=C(CCP(c1ccccc1)c1ccccc1)OCC(COC(=O)CCP(c1ccccc1)c1ccccc1)(COC(=O)CCP(c1ccccc1)c1ccccc1)COC(=O)CCP(c1ccccc1)c1ccccc1] | white oil |
| B-IV-2 | 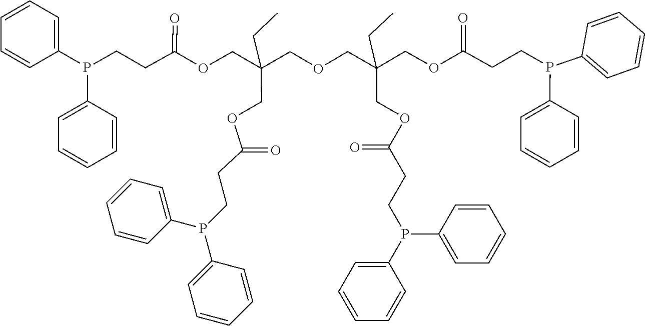 [SMILES: CCC(COCC(CC)(COC(=O)CCP(c1ccccc1)c1ccccc1)COC(=O)CCP(c1ccccc1)c1ccccc1)(COC(=O)CCP(c1ccccc1)c1ccccc1)COC(=O)CCP(c1ccccc1)c1ccccc1] | |

In a preferred embodiment, component B is selected from the group consisting of:

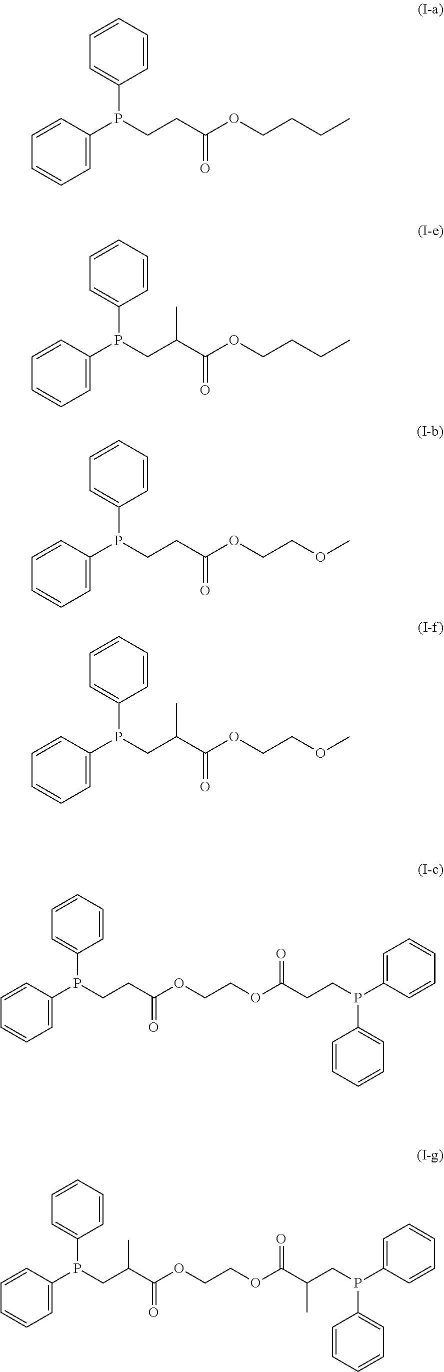 [SMILES: CCCCOC(=O)CCP(c1ccccc1)c1ccccc1 ; CCCCOC(=O)C(C)CP(c1ccccc1)c1ccccc1 ; COCCOC(=O)CCP(c1ccccc1)c1ccccc1 ; COCCOC(=O)C(C)CP(c1ccccc1)c1ccccc1 ; O=C(CCP(c1ccccc1)c1ccccc1)OCCOC(=O)CCP(c1ccccc1)c1ccccc1 ; CC(CP(c1ccccc1)c1ccccc1)C(=O)OCCOC(=O)C(C)CP(c1ccccc1)c1ccccc1]

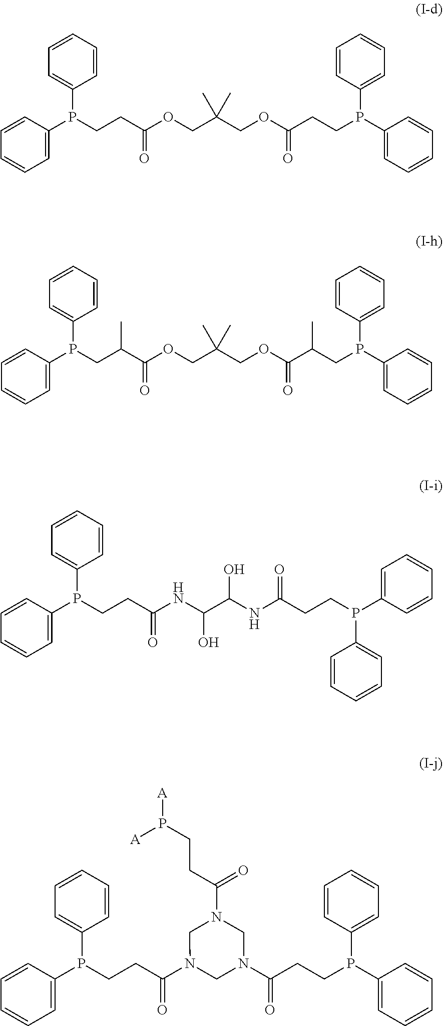

and a mixture of two or more thereof, wherein each A is independently from another an optionally substituted phenyl residue, in particular each an unsubstituted phenyl residue.

A compound according to formula (I) may be obtained by any means. For example, a compound according to formula (I) may be prepared by reacting an optionally substituted diphenylphosphine with a (meth)acrylate or (meth)acrylamide, optionally with the aid of catalytic processes. A compound according to formula (I) may be prepared under very smooth conditions, with the unsaturated bonds originating from acrylates, methacrylates, acrylamides or methacrylamides to form a compounds of formula (I) following one or the schemes below:

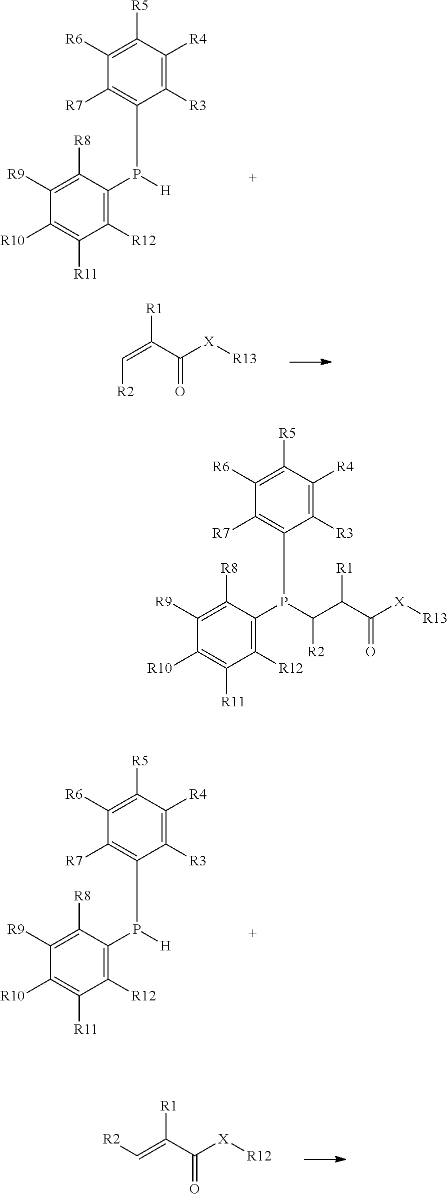

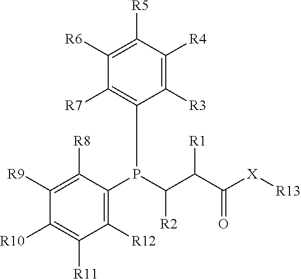

The synthesis of the claimed compounds can also be obtained by procedures without use of a catalyst. Surprisingly such a catalyst-free synthetic route also leads to the inventive diphenylphosphino acrylates and -methacrylates at comparable yields which simplifies the process. Depending on the structure of the acrylic educts a broad variation of diphenylphosphino acrylates and-methacrylates can be obtained. Examples are provided herein in Tables 1A-1D.

The unbound (meth)acrylate or (meth)acrylamide may be added by any means. It may be conducted at a temperature range of from 50° C. to 100° C., from 55° C. to 90° C., from 60° C. to 80° C., from 65° C. to 75° C., or at approximately 70° C. In a preferred embodiment, this conjugation is conducted for at least one hour, for at least two hours, for at least three hours, in a time range of from three to 24 hours, from four to twelve hours, or from five to eight hours. In a preferred embodiment, this conjugation is conducted for at least one hour at a temperature in the range of from 50° C. to 100° C. In a preferred embodiment, this conjugation is conducted for at least three hours at a temperature in the range of from 60° C. to 80° C. In a preferred embodiment, this conjugation is conducted for four to twelve hours at a temperature in the range of from 65° C. to 75° C. In a preferred embodiment, this conjugation is conducted for five to eight hours at a temperature of approximately 70° C.

A further aspect of the present invention relates to a compound of formula (I). A further aspect of the present invention relates to a method for preparing a compound of formula (I) comprising the steps of:
(i) providing an optionally substituted diarylphosphine (diphenylphosphine) and a compound selected from acrylates, methacrylates, acrylamides or methacrylamides;
(ii) reacting the diphenylphosphine) and a compound selected from acrylates, methacrylates, acrylamides or methacrylamides with another; and
(iii) optionally isolating and/or purifying the compound of formula (I).

The content of component B in the composition may be any content suitible for stabilizing the polymer component A.

It has been determined that sufficient stabilizing action can be achieved, if the compound of formula (I) (component B) is used in the range from 5 to 500 ppm, preferably from 10 to 400 ppm, and in particular from 25 to 350 ppm, based on component A. Thus, in a preferred embodiment, the composition comprises 2 to 800 ppm of component B, based on the polymer component A in the composition. In a preferred embodiment, the composition comprises 5 to 500 ppm of component B, based on the polymer component A in the composition. In a preferred embodiment, the composition comprises 10 to 400 ppm of component B, based on the polymer component A in the composition. In a preferred embodiment, the composition comprises composition comprises 25 to 350 ppm of component B, based on the polymer component A in the composition.

In a preferred embodiment, the composition of the invention comprises up to 50% by weight, up to 25% by weight, up to 15% by weight, up to 10% by weight, up to 7.5% by weight, up to 5% by weight, up to 2% by weight, or up to 1% by weight of one or more polymer additives as component C.

In a preferred embodiment, the composition comprises or consists of:
A) 70-99.9998% by weight of one or more polymers as component A;
B) 0.0002-5% by weight of one or more diphenylphosphino compounds of the formula (I) as component B
C) 0-25% by weight of one or more polymer additives as component C.

In a preferred embodiment, the composition comprises or consists of:
A) 99.9-99.9985% by weight of one or more polymers as component A;
B) 0.0005-0.1% by weight of one or more diphenylphosphino compounds of the formula (I) as component B
C) 0.001-10% by weight of one or more polymer additives as component C.

In a preferred embodiment, the composition comprises or consists of:
A) 95.95-99.989% by weight of one or more polymers as component A;
B) 0.001-0.05% by weight of one or more diphenylphosphino compounds of the formula (I) as component B
C) 0.01-5% by weight of one or more polymer additives as component C.

In a preferred embodiment, the composition comprises or consists of: A) 98.96-99.898% by weight of one or more polymers as component A; B) 0.002-0.04% by weight of one or more diphenylphosphino compounds of the formula (I) as component B

C) 0.1-5% by weight of one or more polymer additives as component C.

In a preferred embodiment, the composition of the present invention further comprises one or more polymer additives. A polymer additive may be any additive known in the art for polymer molding masses. In a preferred embodiment, the composition of the present invention further comprises one or more polymer additives as component C, wherein said polymer additives are selected from the group consisting of antioxidants, such as sterically hindered phenols, secondary aromatic amines or thioethers, acid scavengers such as sodium stearate, magnesium stearate, zinc stearate, calcium stearate, sodium lactate, magnesium lactate, zinc lactate and calcium lactate, hydrotalcites or alkoxylated amines; UV stabilizers, and also other sterically hindered amines (HALSs) and UV absorbers, UV quenchers, such as nickel complexes, benzoates and substituted benzoates, antistatics, flame retardants, lubricants, plasticizers, nucleating agents, metal deactivators, biocides, impact modifiers, fillers, dyes, pigments and fungicides.

Additives which may be added to a polymeric formulation of the invention encompass antioxidants, such as sterically hindered phenols, secondary aromatic amines or thioethers; acid scavengers such as sodium stearate, magnesium stearate, zinc stearate and calcium stearate and sodium lactate, magnesium lactate, zinc lactate and calcium lactate, hydrotalcites or alkoxylated amines; UV stabilizers and also other sterically hindered amines (such as N-unsubstituted, N-alkyl, N—O-alkyl or N-acyl substituted 2,2,6,6-tetramethylpiperidine compounds) [also known as hindered amine (light) stabilizers (HA(L)S's)] and UV absorbers (such as 2-(2′-hydroxyphenyl)benzotriazoles, 2-hydroxybenzophenones, (2-hydroxyphenyl)triazines, 1,3-bis(2′-hydroxybenzoyl)benzosalicylates, benzylidene-malonates, oxanilides and cinnamates and oxamides), UV quenchers, such as nickel complexes, benzoates and substituted benzoates, antistats, flame retardants, lubricants, plasticizers, nucleating agents, metal deactivators, biocides, impact modifiers, fillers, pigments and fungicides.

The composition of the present invention may also be designated as polymeric composition or polymer composition. Polymer component A may be prepared from monomeric units by polymerization, polycondensation or polyaddition. In a preferred embodiment, the composition of the present invention is a polymeric molding mass. The polymer component A may be ay polymer component. In a preferred embodiment, the polymer is a thermoplastic polymer. Thus, in a preferred embodiment, the composition is a thermoplastic molding mass.

In a preferred embodiment, the polymer component A is selected from the group consisting of polyolefins, a polystyrene (co)polymers, polyurethanes, polyesters, polyamides, polyacetals and blends and copolymers of two or more thereof, including high-molecular weight polymers and lower-molecular weight polymers such as waxes).

Examples of such polymer component A are polyolefins (polyethylenes (high-density polyethylene (HDPE), low-density polyethylene (LDPE), linear low-density polyethylene (LLDPE), very low-density polyethylene (VLDPE), etc.), polypropylene, polybutylene, cyclo-olefin-copolymers (COC) etc. and copolymers of these), polystyrene, polyurethanes, polyester (e.g. polyethylene terephthalate (PET), polybutylene terephthalate (PBT), polybutylene naphthalate (PBN), etc.), polyamides and polyacetals. Copolymers of these individual polymers are also included, as are blends of various polymers and copolymers (e.g. acrylonitrile butadiene styrene (ABS), styrene-acrylonitrile (SAN), etc.).

The polymer component A stabilized by the compounds of formula (I) may be any polymer known in the art, such as polyolefin homopolymers and copolymers, thermoplastics, rubbers, polyesters, polyurethanes, polyalkylene terephthalates, polysulfones, polyimides, polyphenylene ethers, styrenic polymers and copolymers, polycarbonates, acrylic polymers, polyamides, polyacetals, halide-containing polymers, and biodegradable polymers. Mixtures of different polymers, such as polyphenylene ether/styrenic resin blends, polyvinyl chloride/ABS or other impact modified polymers, such as methacrylonitrile and a-methylstyrene containing ABS, and polyester/ABS or polycarbonate/ABS and polyester plus some other impact modifier may also be used.

Such polymers are available commercially or may be made by means well known in the art. The compounds of formula (I) of the invention may be useful in thermoplastic polymers, such as polyolefins, polycarbonates, polyesters, polyphenylene ethers and styrenic polymers, due to the extreme temperatures at which thermoplastic polymers are often processed and/or used.

The polymers used in combination with compounds of formula (I) of the present invention may be obtained by any means. For example, these may be produced using one of a variety of polymerization processes including solution, high pressure, slurry and gas phase using various catalysts including Ziegler-Natta, single-site, metallocene or Phillips-type catalysts. Non-limiting polymers useful with the compounds of formula (I) include ethylene based polymers such as linear low density polyethylene, elastomers, plastomers, high density polyethylene, substantially linear long chain branched polymers, and low density polyethylene; and propylene based polymers such as polypropylene polymers including atactic, isotactic, and syndiotactic polypropylene polymers, and propylene copolymers such as propylene random, block or impact copolymers.

The polymers, in one preferred embodiment, ethylene based polymers, may have a density in the range of from 0.8 g/cc to 1.0 g/cc, approximately 0.9 g/cc or from 0.86 g/cc to 0.97 g/cc, preferably in the range of from 0.88 g/cc to 0.965 g/cc, from 0.900 g/cc to 0.96 g/cc, from 0.905 g/cc to 0.95 g/cc, from 0.910 g/cc to 0.940 g/cc, greater than 0.915 g/cc, greater than 0.920 g/cc, or greater than 0.925 g/cc. In one embodiment, the polymers have a molecular weight distribution, a weight average molecular weight to number average molecular weight (Mw/Mn) of greater than 1.5 to about 15, greater than 2 to about 10, greater than about 2.2 to less than about 8, from about 2.2 to less than 5, or from 2.5 to 4. The ratio of Mw/Mn may be measured by gel permeation chromatography techniques well known in the art. The polymers, in one embodiment, have a melt index (MI) or (12) as measured by ASTM-D-1238-E in the range from 0.01 dg/min to 1000 dg/min, from about 0.01 dg/min to about 100 dg/min, from about 0.1 dg/min to about 50 dg/min, or from about 0.1 dg/min to about 10 dg/min.

Polymers used as component A may be useful in such forming operations as film, sheet, and fiber extrusion and co-extrusion as well as blow molding, injection molding and rotary molding. Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, membranes, etc. in food-contact and non-food contact applications. Fibers include melt spinning, solution spinning and melt blown fiber operations for use in woven or non-woven form to make filters, diaper fabrics, medical garments, geotextiles, etc. Extruded articles include medical tubing, wire and cable coatings, geomembranes, and pond liners. Molded articles include single and multi-layered constructions in the form of bottles, tanks, large hollow articles, rigid food containers and toys, etc. In addition to the above, the compounds of formula (I) may be used in various rubber based products such as tires, barriers and the like.

In one embodiment, compounds of formula (I) are suitable and/or approved for use in polymers, preferably polyolefins, that may be used in contact with beverages, foods and other human consumables.

Polymers of mono-olefins and di-olefins, for example polypropylene, poly-isobutylene, polybutene-1, poly-methylpentene-1, poly-isoprene, or polybutadiene, as well as polymers of cyclo-olefins, for instance of cyclo-pentene or norbornene, polyethylene (which optionally can be cross-linked), for example high density polyethylene (HDPE), low density polyethylene (LDPE) and linear low density polyethylene (LLDPE) may be used. Mixtures of these polymers, for example, mixtures of polypropylene with poly-isobutylene, polypropylene with polyethylene (for example PP/HDPE, PPILDPE) and mixtures of different types of polyethylene (for example LDPE/HDPE), may also be used. Also useful may be copolymers of mono-olefins and di-olefins with each other or with other vinyl monomers, such as, for example, ethylene/propylene, LLDPE and its mixtures with LDPE, propylene/butene-1, ethylene/hexene, ethylene/ethylpentene, ethylene/heptene, ethylene/octene, propylene/isobutylene, ethylene/butane-1, propylene/butadiene, isobutylene, isoprene, ethylene/alkyl acrylates, ethylene/alkyl methacrylates, ethylene/vinyl acetate (EVA) or ethylene/acrylic acid copolymers (EAA) and their salts (ionomers) and terpolymers of ethylene with propylene and a diene, such as hexadiene, dicyclopentadiene or ethylidene-norbomene; as well as mixtures of such copolymers and their mixtures with polymers mentioned above, for example polypropylene/ethylene propylene copolymers, LDPE/EVA, LDPE/EAA, LLDPE/EVA, and LLDPE/EAA.

The olefin polymers may be produced by, for example, polymerization of olefins in the presence of Ziegler-Natta catalysts. The olefin polymers may also be produced utilizing chromium catalysts or single site catalysts, e.g., metallocene catalysts such as, for example, cyclopentadiene complexes of metals such as Ti and Zr. As one skilled in the art would readily appreciate, the polyethylene polymers used herein, e.g., LLDPE, can contain various co-monomers such as, for example, 1-butene, 1-hexene and 1-octene co-monomers.

The polymer may also include styrenic polymers, such as polystyrene, poly-(p-methylstyrene), poly-(alpha-methylystyrene), copolymers of styrene or a-methylstyrene with dienes or acrylic derivatives, such as, for example, styrene/butadiene (SBR), styrene/acrylonitrile, styrene/alkyl methacrylate, styrene/maleic anhydride, styrene/maleimide, styrene/butadiene/ethyl acrylate, styrene/acrylonitrile/methylacrylate, mixtures of high impact strength from styrene copolymers and another polymer, such as, for example, from a polyacrylate, a diene polymer or an ethylene/propylene/diene terpolymer; and block copolymers of styrene, such as, for example, styrene/butadiene/styrene (SBS), styrene/isoprene/styrene (SIS), styrene/ethylene/butylene/styrene or styrene/ethylene/propylene/styrene.

Styrenic polymers may additionally or alternatively include graft copolymers of styrene or a-methylstyrene such as, for example, styrene on polybutadiene, styrene on polybutadienestyrene or polybutadiene-acrylonitrile; styrene and acrylonitrile (or methacrylonitrile) or polybutadiene and copolymers thereof; styrene and maleic anhydride or maleimide on polybutadiene; styrene, acrylonitrile and maleic anhydride or maleimide on polybutadiene; styrene, acrylonitrile and methyl methacrylate on polybutadiene, styrene and alkyl acrylates or methacrylates on polybutadiene, styrene and acrylonitrile on ethylene-propylene-diene terpolymers, styrene and acrylonitrile on polyacrylates or polymethacrylates, styrene and acrylonitrile on acrylate/butadiene copolymers, as well as mixtures thereof with the styrenic copolymers indicated above.

Suitable rubbers include both natural rubber and synthetic rubbers, and combinations thereof. Synthetic rubbers include, but are not limited to, for example, thermoplastic rubbers, ethylene/alpha-olefin/non-conjugated polyene (EPDM) rubbers, ethylene/alpha-olefin (EPR) rubbers, styrene/butadiene rubbers, acrylic rubbers, nitrile rubbers, poly-isoprene, polybutadiene, poly-chloroprene, acrylonitrile/butadiene (NBR) rubbers, poly-chloroprene rubbers, polybutadiene rubbers, isobutylene-isoprene copolymers, etc. Thermoplastic rubbers include SIS, solution and emulsion SBS, etc.

Nitrile polymers may also be useful in the polymer composition of the invention. These include homo-polymers and copolymers of acrylonitrile and its analogs, such as poly-methacrylonitrile, poly-acrylonitrile, acrylonitrile/butadiene polymers, acrylonitrile/alkyl acrylate polymers, acrylonitrile/alkyl methacrylate/butadiene polymers, and various ABS compositions as referred to above in regard to styrenics.

Polymers based on acrylic acids, such as acrylic acid, methacrylic acid, methyl methacrylic acid and ethacrylic acid and esters thereof may also be used. Such polymers include polymethylmethacrylate, and ABS-type graft copolymers wherein all or part of the acrylonitrile type monomer has been replaced by an acrylic acid ester or an acrylic acid amide. Polymers including other acrylic-type monomers, such as acrolein, methacrolein, acrylamide and methacrylamide may also be used.

Halogen-containing polymers may also be stabilized with one or more compounds of formula (I) of the present invention. These include polymers such as polychloroprene, epichlorohydrin homo-and copolymers, polyvinyl chloride, polyvinyl bromide, polyvinyl fluoride, polyvinylidene chloride, chlorinated polyethylene, chlorinated polypropylene, fluorinated polyvinylidene, brominated polyethylene, chlorinated rubber, vinyl chloride-vinyl acetate copolymers, vinyl chlorideethylene copolymer, vinyl chloride-propylene copolymer, vinyl chloridestyrene copolymer, vinyl chloride-isobutylene copolymer, vinyl chloride-vinylidene chloride copolymer, vinylchloride styrene-maleic anhydride terpolymer, vinyl chloride-styrene-acrylonitrile copolymer, vinylchloride-butadiene copolymer, vinyl chloride isoprene copolymer, vinyl chloride-chlorinated propylene copolymer, vinyl chloride-vinylidene chloride-vinyl acetate terpolymer, vinylchloride-acrylic acid ester copolymers, vinyl chloride-maleic acid ester copolymers, vinylchloride-methacrylic acid ester copolymers, vinyl chloride-acrylonitrile copolymer and internally plasticized polyvinyl chloride.

Other useful polymers include homopolymers and copolymers of cyclic ethers, such as polyalkylene glycols, polyethylene oxide, polypropylene oxide or copolymers thereof with bisglycidyl ethers; polyacetals, such as polyoxymethylene and those polyoxymethylene which contain ethylene oxide as a comonomer; polyacetals modified with thennoplastic polyurethanes, acrylates or methacrylonitrile containing ABS; polyphenylene oxides and sulfides, and mixtures of polyphenylene oxides with polystyrene or polyamides; polycarbonates and polyestercarbonates; polysulfones, polyethersulfones and polyetherketones; and polyesters which may be derived from dicarboxylic acids and diols and/or from hydroxycarboxylic acids or the corresponding lactones, such as polyethylene terephthalate, polybutylene terephthalate, poly-1,4-dimethylol-cyclohexane terephthalate, poly-2-(2,2,4(4-hydroxyphenyl)-propane} terephthalate and polyhydroxybenzoates as well as block copolyetheresters derived from polyethers having hydroxyl end groups.

Polyamides and copolyamides which may be derived from bisamines and dicarboxylic acids and/or from aminocarboxylic acids or the corresponding lactams, such as polyamide 4, polyamide 6, polyamide 6/6, 6/10, 6/9, 6/12 and 4/6, polyamide 11, polyamide 12, aromatic polyamides obtained by condensation of m-xylene bisamine and adipic acid; polyamides prepared from hexamethylene bisamine and isophthalic or/and terephthalic acid and optionally an elastomer as modifier, for example poly-2,4,4 trimethylhexamethylene terephthalamide or poly-m-phenylene isophthalamide may be useful. Further copolymers of the aforementioned polyamides with polyolefins, olefin copolymers, ionomers or chemically bonded or grafted elastomers; or with polyethers, such as for instance, with polyethylene glycol, polypropylene glycol or polytetramethylene glycols and polyamides or copolyamides modified with EPDM or ABS may be used.

In another embodiment, the polymer comprises a biodegradable polymer or compostable polymer. Biodegradable polymers may be those in which the degradation results from the action of naturally occurring microorganisms, such as bacteria, fungi and algae. Compostable polymers undergoes degradation by biological processes during composting to yield CO₂, water, inorganic compounds and a biomass at a rate consistent with other compostable materials. Typically the biodegradable or compostable polymers may be derived from plant sources and may be synthetically produced. Examples of biodegradable or compostable polymers include poly(glycolic acid) (PGA), poly(lactic acid} (PLA), and co-polymers thereof.

Biodegradable or compostable polymers may also be derived from a blend of starch of a plant and a conventional petroleum-based polymer. For example, the biodegradable polymer may be blended with a polyolefin.

Polyolefin, polyalkylene terephthalate, polyphenylene ether and styrenic polymers, and mixtures thereof are preferred, with polyethylene, polypropylene, polyethylene terephthalate, polyphenylene ether homopolymers and copolymers, polystyrene, high impact polystyrene, polycarbonates and ABS-type graft copolymers and mixtures thereof being preferred.

In a preferred embodiment, the polymer component A is a polyolefin or a blend of polyolefins. A series of thermoplastic polymers, mainly polyolefins, may be protected by the inventive diphenylphosphino acrylates and -methacrylates (component B).

Moreover, the component B of an inventive composition may be added in the form of mixtures with other additives, e.g. those mentioned above, when it is introduced as described into the polymer. These mixtures, also termed blends, may be prepared by mixing the powders, compacting, extrusion or melt pelletization or a similar method.

It will be understood that articles and products may be prepared by the composition of the present invention. Therefore, a further aspect of the present invention relates to an article or product comprising or consisting of the composition of the present invention.

It will be understood that the definitions and preferred embodiments as laid out in the context of the composition of the present invention above mutatis mutandis apply to an article or product comprising such or consisting thereof.

As indicated above, component B according to the present invention (i.e., one or more compounds of formula (I) as defined herein) may serve as stabilizing agent.

Accordingly, a further aspect of the present invention relates to the use of a component B according to the present invention for stabilizing a polymer composition with respect to exposure to heat and/or mechanical stress during processing.

It will be understood that the definitions and preferred embodiments as laid out in the context of the composition of the present invention above mutatis mutandis apply to the use of component B. In a preferred embodiment, the polymer composition comprises one or more polyolefins as component A, in particular wherein the composition is defined as laid out above.

The polymer composition preferably comprises a polymer component A as defined herein. Preferably, the polymer composition is a composition according to the present invention.

As used herein, stabilizing a polymer composition may be understood in the broadest sense as any prevention or diminishing of (undesired) structural changes in the molecular structure of the polymer upon processing. One criterion for successful stabilizing action in the melt is the improved maintenance of the initial molecular weight of the polymer after the polymer has been processed and, respectively, the technical determination of the same by measuring the melt flow index (MFI) (e.g., determined at 230° C., 2.16 kg according to ASTM D-1238-70) as well as measuring the discoloration arising as a result of processing. Improved maintenance of the initial molecular weight is preferably improvement in comparison to a comparable composition lacking component B of the present invention. In a preferred embodiment, the melt flow index (MFI) (e.g., determined at 230° C., 2.16 kg according to ASTM D-1238-70) does not alter more than 25% when a melt of the polymer component A is processed (e.g., at a temperature of 180-300° C.). In a preferred embodiment, the melt flow index (MFI) (e.g., determined at 230° C., 2.16 kg according to ASTM D-1238-70) does not alter more than 10% when a melt of the polymer component A is processed (e.g., at a temperature of 180-300° C.).

As far as not defined otherwise, the ASTM norms mentioned herein refer to the ASTM norms in force and up-to-date on May 1, 2018).

The one or more compounds according to formula (I) (component B) may be added to the polymeric material (component A) and optionally the one or more polymer additives (component C) prior to, during or following the preparation process and the addition may use a solid or molten form or a solution or suspension, preferably a liquid concentrate comprising from 10 to 80% by weight of the one or more compounds according to formula (I) (component B) and from 90 to 20% by weight of the solvent or a solid concentrate composition (masterbatch) comprising from 10 to 80% by weight (in particular from 40 to 70% by weight) of component B and from 90 to 20% by weight (in particular from 60 to 30% by weight) of a solid polymeric material which is identical or compatible with the material to be stabilized (i.e., component A). Depending on the polymer type, such decomposition may lead to an undesired reduction of chain length (typically decreasing viscosity of the melt).and/or to an undesired crosslinking of polymer strands (typically increasing viscosity of the melt). The viscosity of the polymer melt at a given temperature may alter.

An additional or alternative criterion for successful stabilizing action in the melt is the improved maintenance of color of the polymer after the polymer has been processed and, respectively, the technical determination of the same by measuring the yellowness index (e.g., according to ASTM D1925-70). Improved maintenance of the color is preferably improvement in comparison to a comparable composition lacking component B of the present invention. In a preferred embodiment, the yellowness index (e.g., according to ASTM D1925-70) does not alter more than 25% when a melt of the polymer component A is processed (e.g., at a temperature of 180-300° C.). In a preferred embodiment, the yellowness index (e.g., according to ASTM D1925-70) does not alter more than 10% when a melt of the polymer component A is processed (e.g., at a temperature of 180-300° C.).

A still further aspect of the present invention relates to a method for stabilizing a polymer composition with respect to exposure to heat and/or mechanical stress during processing, wherein said method comprises the steps of
(i) providing one or more polymers as component A and one or more diphenylphosphino compounds as component B and optionally one or more polymer additives according to the present invention; and
(ii) melt processing the one or more polymers of component A in the presence of component B.

It will be understood that the definitions and preferred embodiments as laid out in the context of the composition of the present invention and the use of component B above mutatis mutandis apply to a method for stabilizing a polymer composition. In a preferred embodiment, the polymer composition comprises one or more polyolefins as component A, in particular wherein the composition is defined as laid out above.

The temperature of melt processing the one or more polymers of component A depends on the one or more polymers used. Often, such temperature will be in the range of between 180 and 300° C. For example, it may be in the range of from 200 to 280° C. In a preferred embodiment, the step of melt processing involves extrusion, blow-forming and/or injection molding.

A still further aspect of the present invention relates to a method for preparing a composition of the present invention, wherein said method comprises the steps of
(i) providing one or more polymers as component A and one or more diphenylphosphino compounds as component B according to the present invention; and
(ii) melt processing the one or more polymers of component A in the presence of component B.

It will be understood that the definitions and preferred embodiments as laid out in the context of the composition of the present invention, the use of component B and a method for stabilizing a polymer composition above mutatis mutandis apply to any of the methods for preparing such.

The Examples and claims further illustrate the present invention.

### EXAMPLES

Synthesis of the Compounds of Formula (I)

In a dried Schlenk tube under argon the diarylphosphine of the general formula PAr₂H (e.g., P(Ph)₂H, diphenylphosphine) dissolved in 2-methyl-tetrahydrofurane (Me-THF) was added. To this solution, the alk-1-ene derivative ((meth)acrylate or (meth)acrylamide)was drop wise slowly added via a dropping funnel. The Schlenk tube was safely closed and the reaction mixture was then heated for 6 hours at 70° C. When the reaction was completed, the solvent was evaporated under vacuum and the obtained product (usually an oil)was precipitated by adding n-hexane. The obtained powder was then filtered and washed twice with n-hexane before being dried under vacuum.

Application in Polypropylene During Processing—Examples

Mixing of ingredients took place by using a Kenwood mixer with K-shape mixing blade. Mixing was carried out by slow agitation during 5 minutes (1.2 kg per batch, 1 batch). It is useful to manually mix/distribute liquid ingredients with some part of the resin (powder) before further mix the whole batch in Kenwood mixer. Additives which were not available in powder form had to be crushed before further mixing with all other ingredients in the Kenwood mixer. The resin was optionally sieved with a mesh size of up to 2.5 mm.

Pre-extrusion was carried out by means of a Collin single screw extruder with water bath. A screw configuration with diameter 30, compression ratio 1:4 and L/D ratio 25 was chosen. The die has a diameter of 3 mm and was operating with a screw speed of 70 rpm. Cooling takes place in water. Pelletization takes place with high-speed mode (Pelletizer T1). Procedure: Single pass compounding, taking sample as pass 0. This was performed according to the following scheme:

Multiple Extrusion:

Instrument: Gottfert Single Screw Extruder (Extruder III), screw diameter 20 mm, L/D ratio 22, Compression ratio 1:4, die: Single hole, Diameter 3 mm, barrel temperature: 240° C.

A polymeric composition comprising:

100.0 parts of polypropylene (e.g., PP (BOPP, biaxially oriented polypropylene) as component A),

0.07 parts of Hostanox P-EPQ® (commercial comparative example),

0.05 parts of Hostanox O 10® (component C), and

0.1 parts of calcium stearate (component C),

was mixed by dry mixing and pre-extrusion at 210° C. The composition was then repeatedly extruded at a temperature of 270° C. and pelletized in a water bath after cooling of the polymer melt. The melt flow index (MFI; 230° C., 2.16 kg) (ASTM D-1238-70) and the Yellowness Index (YI) (ASTM D1925-70) using pellets were determined after the first, third and fifth pass.

The experimentally used polypropylene (BOPP) is a (non-stabilized) homopolymer polypropylene having a density of approximately 0.9 g/cc (according to ASTM D-792), a melt flow rate of approximately 2.9 g/10 min (according to ASTM D-1238, at 230° C., 2.16 kg) and a melting temperature of between approximately 155 and 160° C. (according to ASTM D-3418).

Hostanox O 10 (producer Clariant Corp.) is a highly established tetrafunctional sterically hindered phenol which mainly acts as long-term thermal stabilizer in various technical polymers. This phenol is produced and commercialized under numerous brandnames (e.g., Hostanox 0 10 Songnox 1010, Inganox 1010, Anox 20):

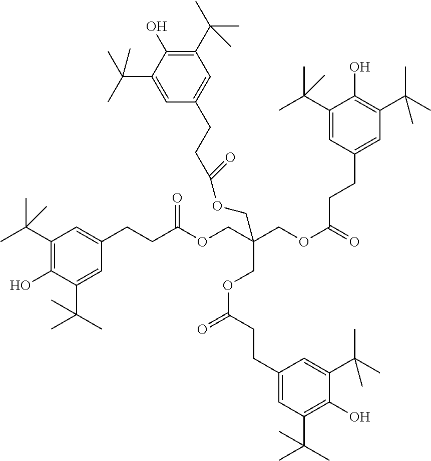 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

Hostanox P-EPQ (producer Clariant Corp.) is a well-established bisfunctional organophosphonite which acts as stabilizer during processing of certain technical polymers, particularly of polyolefins:

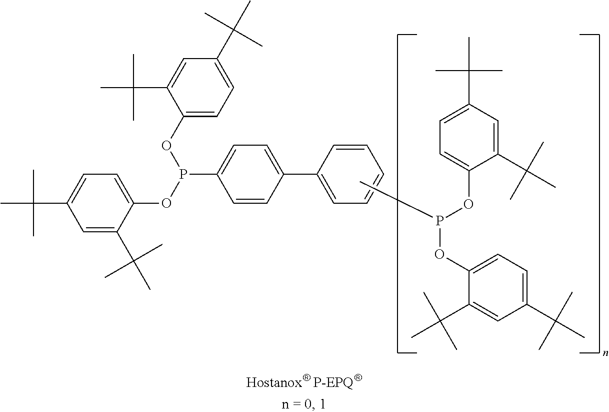

PS 168 is phosphite stabilizer 168. This is a commercial stabilizer (Ciba Irgafos 168) that is, chemically, tris(2,4-ditert-butylphenyl)phosphite.

BS is a base stabilization such as 500 ppm zinc stearate and 500 ppm of a primary antioxidant such as Ciba Irganox 1076.

Melt flow rate (MFR):

Instrument: CEAST MF50 Advanced Melt Flow tester, Multi-weight Instrument

Setup (according to ISO 1133B); bore temperature: 230° C.

Measure mode type: position

Measure start position: 50.00 mm.

Measure end position: 20.00 mm.

Measurement details:

measure load: 2.16 kg; measure length:10 mm. measure steps: 10. measure melt density: 0.742 g/cm³; die diameter: 2.095 mm.

Compacting:

compacting delay: 60; compacting force: 21.6 kg; compacting quote: 52 mm; weight apply delay: 240s; sample weight: 4 g.

Color:

Measuring colorimetric values (L*, a*, b*, YI and dE); instrument:

Spectrophotometer Minolta, model 3600d, mode: Reflectance SCE

Table 2 shows the results with regard to melt flow rate (MFR) of selected inventive compounds in comparison to established commercial P-based stabilizers.

TABLE 2
Melt flow rate (MFR) of polypropylene by multiple
pass extrusion at T = 270° C.

| Formulation and concentration of | MFR (g/10 min) | | | |
|---|---|---|---|---|
| P-based stabilizer | Pass 0 | Pass 1 | Pass 3 | Pass 5 |
| only base stabilization (BS) | | 7.04 | 17.84 | 32.54 |
| (Comparative Example) | | | | |
| BS + 1000 ppm PS 168 | 2.10 | 3.71 | 4.77 | 6.17 |
| (Comparative Example) | | | | |
| BS + 700 ppm Hostanox P-EPQ | 2.46 | 3.00 | 3.81 | 4.80 |
| (Comparative Example) | | | | |
| BS + 700 ppm B-II-3 | 2.66 | 3.00 | 3.35 | 3.95 |
| BS + 700 ppm B-II-4 | 2.61 | 3.12 | 3.66 | 4.44 |
| BS + 700 ppm B-II-6 | 2.57 | 2.89 | 3.71 | 4.50 |
| BS + 700 ppm B-III-1 | 2.66 | 3.02 | 3.42 | 4.13 |
| BS + 700 ppm B-IV-2 | 2.61 | 2.89 | 3.52 | 3.84 |

The following conclusions can be drawn from these results:
Polypropylene degrades with reduction of chain length and therefore of viscosity, giving an increase in MFI values. Compared with commercial organophosphonite Hostanox P-EPQ®, the phosphino (meth)acrylates of the present invention (compounds B-II-3, B-II-4, B-II-6, B-III-1, and B-IV-2 as shown above) outperform the commercial product Hostanox P-EPQ® with respect to polymer stability upon heating.
Analogous conclusions may also be reached for the color values (YI). Here, again, it can be seen that the claimed compounds have better effectiveness than the conventional processing stabilizers.

Application in Linear Low Density Polyethylene (LLDPE):

A polymeric composition comprising

100.0 parts of linear-low-density polyethylene (LLDPE) (component A),

0.07 part of the respective P-based stabilizer (component B),

0.03 part of Hostanox O 16° (component C), and

0.05 part of calcium stearate (component C).

was mixed by dry mixing and pre-extrusion at 210° C. The composition was then repeatedly extruded and pelletized in a water bath after cooling of the polymer melt. The melt flow index (MFI) (ASTM D-1238-70, 230° C./2.16 kg) and the Yellowness Index (YI) (ASTM D1925-70) on pellets) were determined after the first, third and fifth pass. The table below shows the results:

The experimentally used LLDPE is a (non-stabilized) linear-low-density polyethylene (LLDPE) having a density of approximately 0.9 g/cc (according to ASTM D-792), a melt mass-flow rate of approximately 1.0 g/10 min (according to ASTM D-1238, at 190° C., 2.16 kg) and a melting temperature of between 120 and 130° C.

TABLE 3
Results of the multiple pass extrusion of LLDPE at T = 240° C.

| | MFR (g/10 min) | | | |
|---|---|---|---|---|
| Concentration P-compound | Pass 0 | Pass 1 | Pass 3 | Pass 5 |
| 1200 ppm TNPP | 1.987 | 1.965 | 1.895 | 1.770 |
| (Comparative Example) | | | | |
| 700 ppm Hostanox P-EPQ | 1.986 | 1.976 | 1.762 | 1.587 |
| (Comparative Example) | | | | |
| 700 ppm B-II-1 | 1.983 | 1.990 | 2.003 | 1.833 |
| 700 ppm B-III-3 | 1.998 | 1.962 | 1.900 | 1.617 |
| 700 ppm B-III-2 | 1.991 | 2.003 | 2.004 | 1.965 |
| 700 ppm B-II-2 | 1.993 | 2.004 | 2.033 | 2.009 |
| 700 ppm B-2 | 2.015 | 1.994 | 2.053 | 2.021 |
| 700 ppm B-1 | 1.941 | 1.987 | 2.036 | 1.978 |
| 700 ppm B-II-5 | 1.981 | 2.034 | 2.037 | 2.019 |
| 700 ppm B-4 | 1.991 | 2.037 | 2.043 | 1.930 |

The following conclusions may be drawn from these results:
LLDPE usually degrades by means of crosslinking. Therefore with a rise in viscosity lower MFI values are measured. Even at low concentrations, the stabilizers of the invention exhibit better action than the conventional phosphonite Hostanox P-EPQ® towards retention respectively stabilization of the molecular weight during processing with respect to polymer stability upon heating.
For the compound of the invention, it can be seen e.g. using the inventive products B-1, B-2, B-4, B-II-1, B-II-2, B-II-5, B-III-2 and B-III-3 that the melt flow stabilization obtained is virtually ideal, with MFI values remaining the same across the five extrusion processes.
Towards retention of color particularly the phosphino (meth)acrylates B-II-2 and B-III-2 exhibit superior performance and are in this respect basically equivalent to Hostanox P-EPQ®.

1. A composition comprising:
A) one or more polymers as component A;
B) one or more diphenylphosphino compounds of the formula (I) as component B 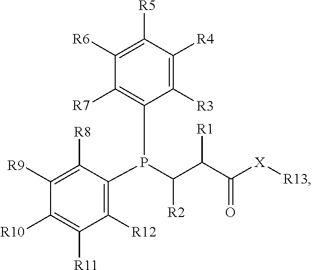
where, independently of one another
R1 is selected from the group consisting of linear or branched C₁₋₁₂-alkyl, hydrogen, and carboxylate from the formula COOR^{a}, wherein R^{a} is linear or branched C₁₋₂₀-alkyl;
R2 is selected from the group consisting of hydrogen, linear or branched 18-alkyl, and linear or branched C₁₋₁₂-alkoxy;
R3 to R12 are each independently from each other selected from the group consisting of hydrogen, linear or branched C₁₋₁₈-alkyl, and linear or branched C₁₋₁₂-alkoxy;
X is O or NH;
P is phosphorous; and
R13 is selected from the group consisting of linear or branched C₁₋₂₀-(cyclo)alkyl, linear or branched C₁₋₂₀-(cyclo)heteroalkyl, C₆₋₃₀-aryl, C₁₋₂₉-heteroaryl, alkyl terminated polyethylene glycol, and polypropylene glycol chain,
wherein the residues of R13 may optionally be substituted by one or more linear or branched C₁₋₂₀-(cyclo)alkyl residues, linear or branched C₁₋₂₀-(cyclo)heteroalkyl residues, C₆₋₃₀-aryl residues, or C₁₋₂₉-heteroaryl residues, and
wherein two or more residues R13 of two or more diarylphosphino units of formula (I) may optionally be conjugated with another; and
C) optionally one or more polymer additives as component C.

2. The composition of claim 1, wherein at least 8 of R2 to R12 are each hydrogen.

3. The composition of claim 1, wherein R2 is hydrogen.

4. The composition of claim 1, wherein all of R2 to R12 are each hydrogen.

5. The composition of claim 1, wherein component B is selected from the group consisting of: 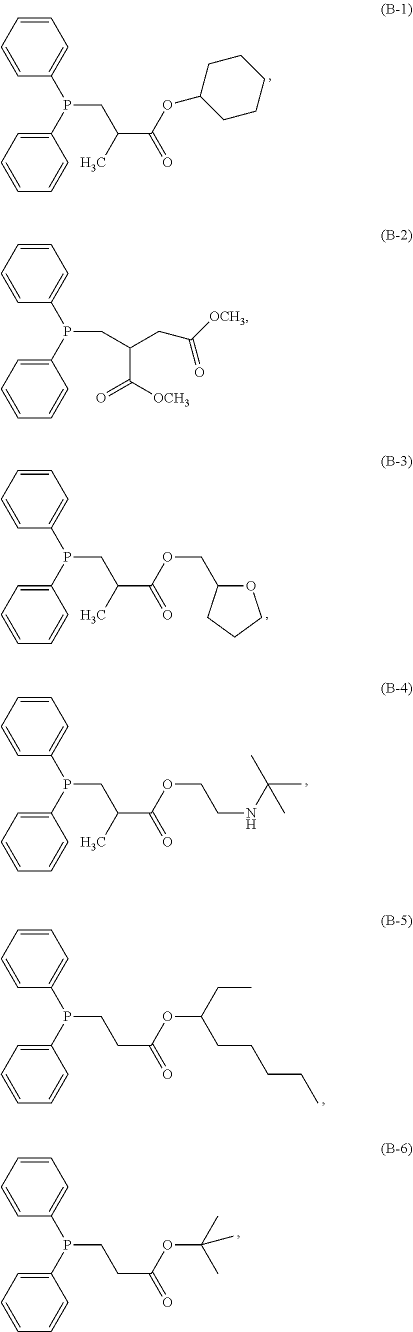 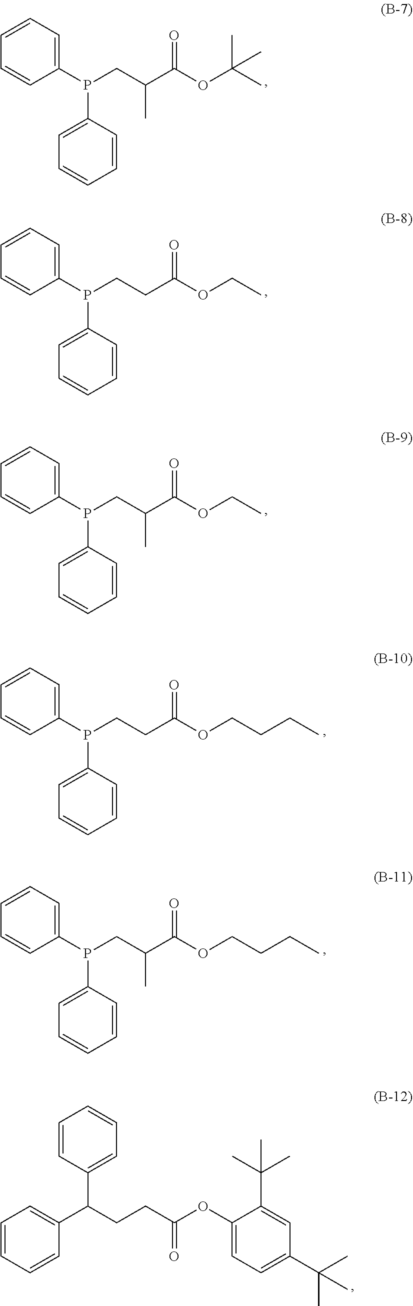 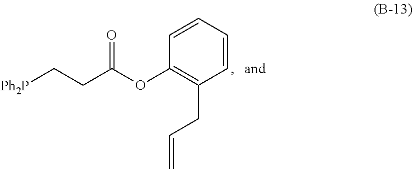
a mixture of two or more thereof.

6. The composition of claim 1, wherein component B is selected from the group consisting of: 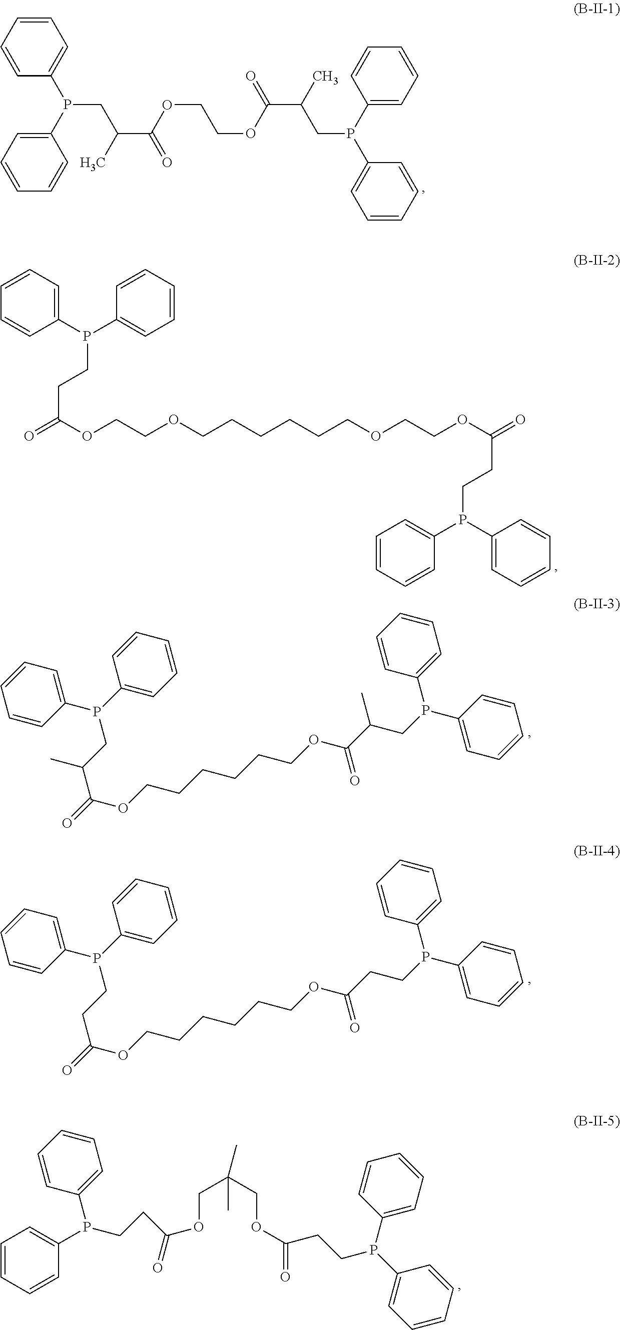 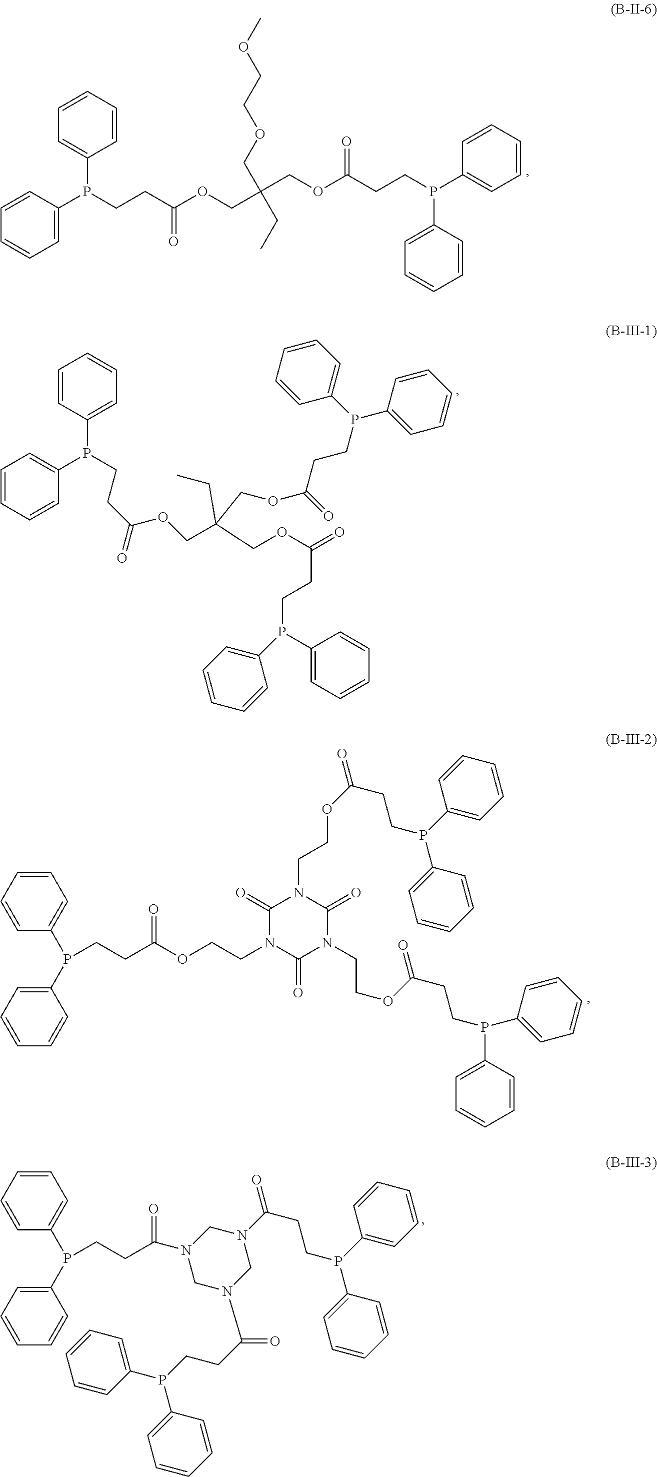 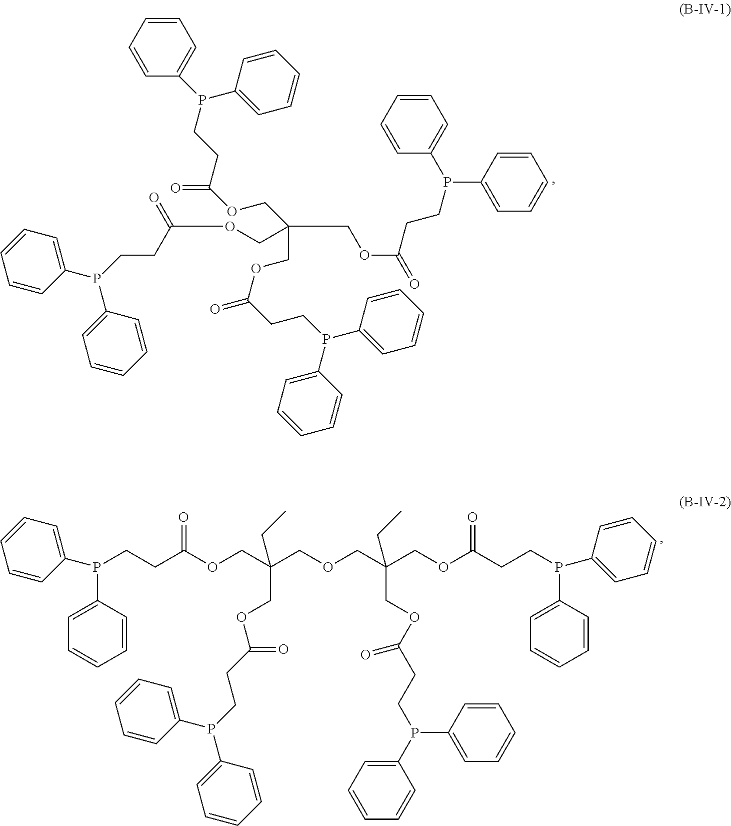 [SMILES: O=C(CCP(c1ccccc1)c1ccccc1)OCC(COC(=O)CCP(c1ccccc1)c1ccccc1)(COC(=O)CCP(c1ccccc1)c1ccccc1)COC(=O)CCP(c1ccccc1)c1ccccc1 ; "," ; CCC(COCC(CC)(COC(=O)CCP(c1ccccc1)c1ccccc1)COC(=O)CCP(c1ccccc1)c1ccccc1)(COC(=O)CCP(c1ccccc1)c1ccccc1)COC(=O)CCP(c1ccccc1)c1ccccc1 ; ","]
and
a mixture of two or more thereof.

7. The composition of claim 1, wherein component B is selected from the group consisting of: 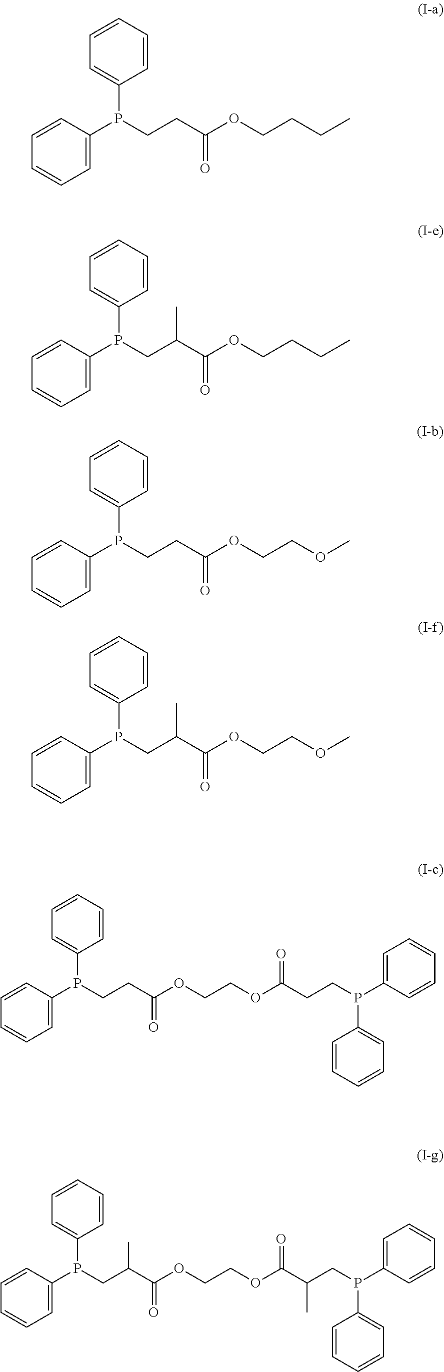 [SMILES: CCCCOC(=O)CCP(c1ccccc1)c1ccccc1 ; CCCCOC(=O)C(C)CP(c1ccccc1)c1ccccc1 ; COCCOC(=O)CCP(c1ccccc1)c1ccccc1 ; COCCOC(=O)C(C)CP(c1ccccc1)c1ccccc1 ; O=C(CCP(c1ccccc1)c1ccccc1)OCCOC(=O)CCP(c1ccccc1)c1ccccc1 ; CC(CP(c1ccccc1)c1ccccc1)C(=O)OCCOC(=O)C(C)CP(c1ccccc1)c1ccccc1] 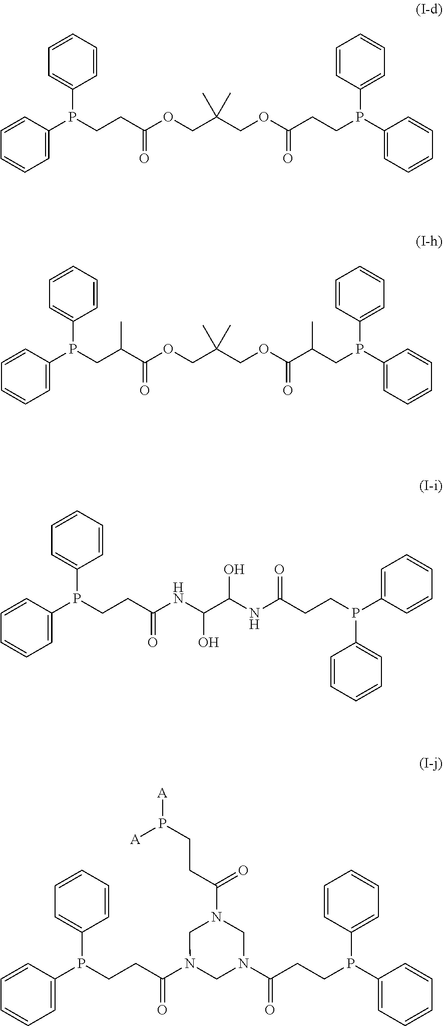
and a mixture of two or more thereof, wherein each A is independently from another an optionally substituted phenyl residue.

8. The composition of claim 1, wherein said composition comprises 2 to 800 ppm of component B, based on the polymer component A in the composition.

9. The composition of claim 1, wherein said composition comprises 25 to 350 ppm of component B, based on the polymer component A in the composition.

10. The composition of claim 1, rein said composition is a thermoplastic molding mass.

11. The composition of claim 1, wherein the polymer component A is selected from the group consisting of polyolefins, a polystyrene (co)polymers, polyurethanes, polyesters, polyamides, polyacetals and blends and copolymers of two or more thereof.

12. The composition of claim 1, wherein said composition further comprises one or more polymer additives as component C, wherein said polymer additives are selected from the group consisting of antioxidants, such as sterically hindered phenols, secondary aromatic amines or thioethers, acid scavengers such as sodium stearate, magnesium stearate, zinc stearate, calcium stearate, sodium lactate, magnesium lactate, zinc lactate and calcium lactate, hydrotalcites or alkoxylated amines; UV stabilizers, and also other sterically hindered amines (HALSs) and UV absorbers, UV quenchers, such as nickel complexes, benzoates and substituted benzoates, antistatics, flame retardants, lubricants, plasticizers, nucleating agents, metal deactivators, biocides, impact modifiers, fillers, dyes, pigments and fungicides.

13. (canceled)

14. A method for stabilizing a polymer composition with respect to exposure to heat, mechanical stress or both during processing, wherein said method comprises the steps of:
(i) providing one or more polymers as component A, wherein said composition is a thermoplastic molding mass, and one or more diphenylphosphino compounds as component B according to claim 1, and optionally one or more polymer additives as component C; and
(ii) melt processing the one or more polymers of component A in the presence of component B.

15. The method of claim 14, wherein the polymer composition comprises one or more polyolefins as component A.

16. The method of claim 14, wherein the composition is defined as in claim 1.

17. The composition of claim 7, wherein each A is independently from another an unsubstituted phenyl residue.
